(19) United States
(12) Patent Application Publication
(10) Pub. No.: US 2016/0109130 A1
(43) Pub. Date: Apr. 21, 2016

(54) PRODUCTION OF TURBINE COMPONENTS WITH HEAT-EXTRACTING FEATURES USING ADDITIVE MANUFACTURING

(71) Applicant: PRATT & WHITNEY CANADA CORP., Longueuil (CA)

(72) Inventors: Honza STASTNY, Georgetown (CA); Francois RICHARD, St-Denis-sur-Richelieu (CA); Marjolaine COTE, Longueuil (CA)

(21) Appl. No.: 14/671,229

(22) Filed: Mar. 27, 2015

Related U.S. Application Data
(60) Provisional application No. 62/065,525, filed on Oct. 17, 2014.

(51) Int. Cl. F23R 3/04; B23K 26/342; F23R 3/00

(52) U.S. Cl. CPC F23R 3/04; F23R 3/002; B23K 26/342

(57) ABSTRACT

Turbine engine components having heat-extracting features and methods for manufacturing such components using additive manufacturing are disclosed. An exemplary method comprises providing a base portion of the engine component manufactured by a first manufacturing process and adding one or more heat-extracting features to the engine component using a second manufacturing process different from the first manufacturing process where the second manufacturing process comprises an additive manufacturing process.

### CROSS REFERENCE TO RELATED APPLICATION AND CLAIM OF PRIORITY

The present application claims priority to U.S. provisional patent application No. 62/065,525 flied on Oct. 17, 2014, the entire contents of which are hereby incorporated by reference.

### TECHNICAL FIELD

The disclosure relates generally to heat extraction from gas turbine engine components, and more particularly to manufacturing components with heat-extracting features using additive manufacturing.

### BACKGROUND OF THE ART

Combustors used in gas turbine engines, such as those used in aircraft or power generation, can generate combustion gases at very high temperatures. These temperatures are often high enough to damage the combustor wall unless sufficient cooling is provided. Cooling of combustor walls must be adequate to achieve the expected life of the combustor. In some cases, cooling can be achieved by means of protection such as thermal barrier coatings, diffusion air cooling holes, impingement cooling, transpiration cooling, effusion cooling, or convective cooling. Existing solutions for achieving cooling of combustor walls can add to the cost and complexity of the combustor walls.

Improvement is therefore desirable.

### SUMMARY

In one aspect, the disclosure describes a method for manufacturing a component of a turbine engine, the component for exposure to a heat source when used in the turbine engine. The method comprises:

providing a base portion manufactured by a first manufacturing process, the base portion comprising a first surface and a second surface, the first surface for exposure to the heat source and the second surface for exposure to a cooling fluid when used in the turbine engine; and

adding a heat-extracting feature on the second surface of the base portion using a second manufacturing process different from the first manufacturing process, the second manufacturing process comprising an additive manufacturing process, the heat-extracting feature having a longitudinal axis being non-normal to the second surface at a location of the heat-extracting feature on the second surface.

In another aspect, the disclosure describes a gas turbine engine component comprising:

a base portion comprising a first surface and an opposite second surface, the first surface for exposure to a heat source and the second surface for exposure to a cooling fluid when used in the gas turbine engine; and

a heat-extracting feature on the second surface of the base portion, the heat-extracting feature having a longitudinal axis being non-normal to the second surface at a location of the heat-extracting feature on the second surface.

In a further aspect, the disclosure describes a gas turbine engine comprising one or more components as described herein.

Further details of these and other aspects of the subject matter of this application will be apparent from the detailed description and drawings included below.

### DESCRIPTION OF THE DRAWINGS

Reference is now made to the accompanying drawings, in which:

FIG. 1 shows a schematic axial cross-sectional view of an exemplary gas turbine engine;

FIG. 2 is a perspective view of a portion of an exemplary component of the engine of FIG. 1 manufactured according to a method disclosed herein;

FIG. 3 is a perspective view of a portion of another exemplary component of the engine of FIG. 1 manufactured according to a method disclosed herein;

FIG. 4 is a perspective view of a portion of another exemplary component of the engine of FIG. 1 manufactured according to a method disclosed herein;

FIG. 5 is an enlarged perspective view of an exemplary heat-extracting feature added on one of the engine components shown in FIGS. 2, 3 and 4;

FIG. 6 is an enlarged side elevation view of another exemplary heat-extracting feature added on one of the engine components shown in FIGS. 2, 3 and 4;

FIG. 7 is a top plan of a portion of another exemplary component of the engine of FIG. 1 manufactured according to a method disclosed herein;

FIG. 8 is a flowchart illustrating an exemplary method for manufacturing an engine component as described herein;

FIG. 9A is a cross-sectional view of an exemplary base portion of the engine component of FIG. 2 without heat-extracting features, taken along line 9-9 in FIG. 2;

FIG. 9B is a cross-sectional view of the base portion of FIG. 9A with a plurality of heat-extracting features added thereon;

FIG. 9C is a cross-sectional view of the base portion of FIG. 9A with inclined heat-extracting features added thereon in proximity to a side wall; and

FIGS. 10A and 10B are schematic representations of part of an additive manufacturing apparatus positioned near a side wall of the base portion of FIG. 9A in preparation for the addition of a heat-extracting feature.

### DETAILED DESCRIPTION

The present disclosure describes components having heat-extracting features and methods for manufacturing such components using additive manufacturing (e.g., sometimes referred to as 3D printing) processes. In some embodiments, additive manufacturing may be used to add one or more heat-extracting features onto a relatively large part manufactured using one or more conventional manufacturing processes such as casting, machining and/or sheet metal forming for example. The addition of the heat-extracting features to an existing base portion of a component may be more economical and/or simpler than manufacturing both the base portion and the heat-extracting features using the same manufacturing process(es). In some embodiments, the base portion may be significantly larger than one or more of the heat-extracting features and therefore may be better suited to be manufactured by, for example, casting, machining and/or sheet metal forming instead of additive manufacturing. In some cases, the use of additive manufacturing may also provide some added flexibility and freedom with designing the geometry of the heat-extracting features to provide the desired heat extraction performance.

As referenced in the present disclosure additive manufacturing includes processes of joining materials to make objects from 3D model data, usually layer upon layer, as opposed to subtractive manufacturing methodologies. Additive manufacturing processes are sometimes also referred to as additive fabrication, additive processes, additive techniques, additive layer manufacturing, layer manufacturing, and freeform fabrication. For example, additive manufacturing can include directed energy deposition where focused thermal energy is used to fuse material(s) (e.g., in powder form) by melting as it/they is/are being deposited. For the purpose of the present disclosure, any known or other material additive process(es) that may be used for adding functional metallic components to a substrate may be suitable.

For example, such additive manufacturing process may include a known or other laser-based material additive process such as a laser material (e.g., powder) deposition process. For example, such additive manufacturing process may be of the type known as “Laser Consolidation” developed at the National Research Council of Canada. Accordingly, the heat-extracting features disclosed herein may be added (e.g., grown, deposited) layer-by-layer on a substrate. For example, a suitable additive manufacturing process may comprise irradiating a laser beam onto a metallic substrate to produce a molten pool of metal into which a metallic powder is injected in order to increase the size of the molten pool and simultaneously causing movement between the laser beam/powder stream and the substrate along a desired trajectory to build a layer of the feature that is added. The addition (i.e., stacking) of subsequent layers may be used to achieve a desired height and geometry of the added feature. Such additive manufacturing process may make use of a multi-axis computer numerical control (CNC) system to cause movement between the laser beam/powder stream and the substrate in order to add a feature having the desired geometry.

In some embodiment, an additive manufacturing process having a relatively low heat input may be suitable. In some embodiments, the additive manufacturing process may produce an interface between a heat-extracting feature and the base portion that comprises a metallurgical bond that is free of filler material(s) that could otherwise be required if welding or brazing was used. The additive manufacturing process may be suitable for adding heat-extracting features having one or more characteristics described and/or illustrated herein.

The examples provided in the present disclosure relate mainly to heat-extracting features on turbine engine components to provide cooling but it is understood that aspects of the present disclosure could also apply to other types of components used in other applications.

Aspects of various embodiments are described through reference to the drawings.

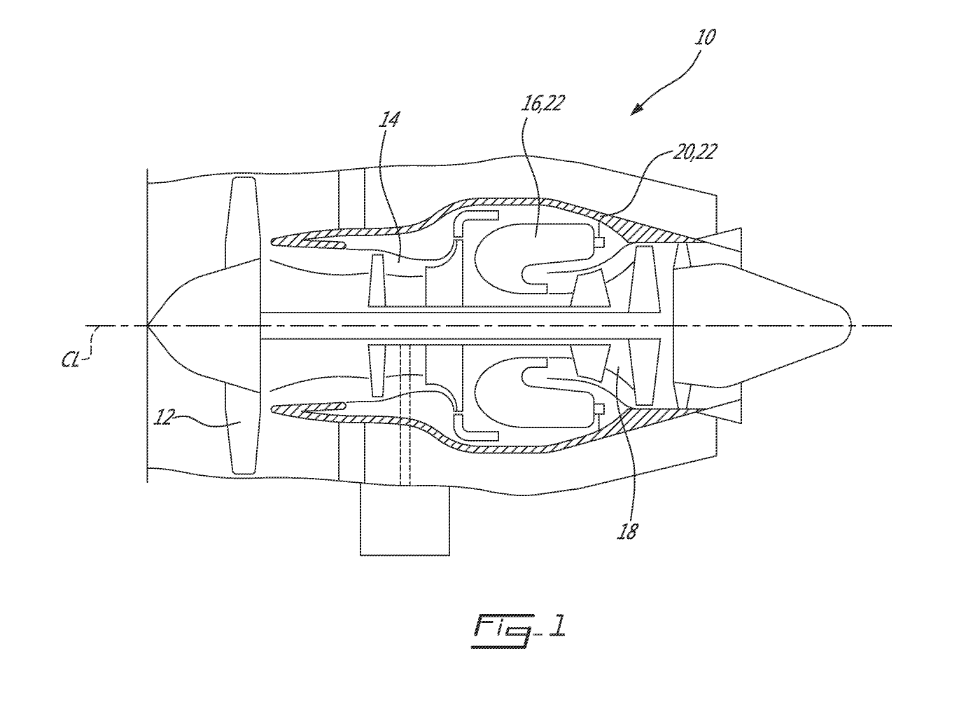

FIG. 1 illustrates an exemplary gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases. Gas turbine engine 10 may also comprise engine casing 20. Gas turbine engine 10 may be of the type suitable for aircraft applications.

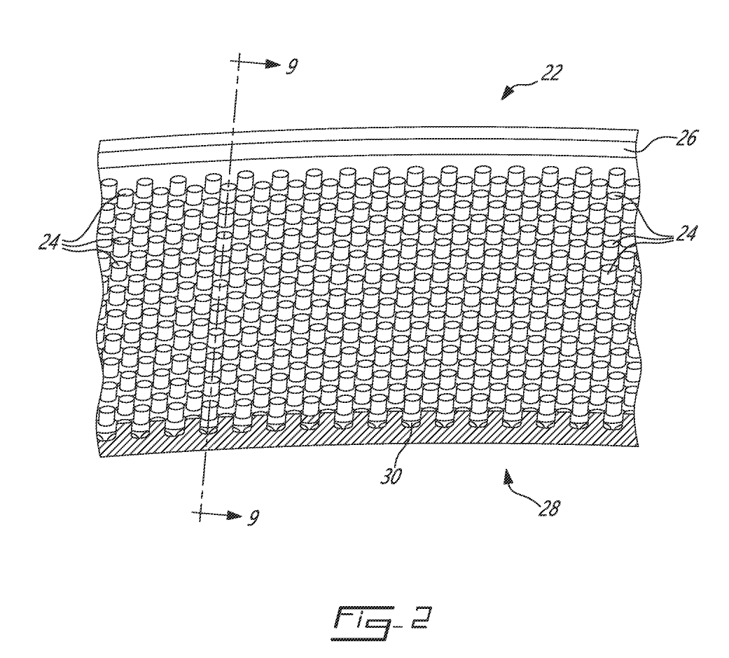

FIG. 2 is a perspective view of an exemplary portion of an annular gas turbine engine component 22 (referred hereinafter as “engine component 22”) which may be manufactured using the methods disclosed herein. Engine component 22 may comprise any metallic component of gas turbine engine 10 that may require heat to be extracted from it (i.e., cooling). For example, engine component 22 may be part of combustor 16 or engine (e.g., turbine or compressor) casing 20 of engine 10. In some embodiments, engine component 22 may comprise a floating wall panel of a combustor 16 of engine 10. Heat extraction from engine component 22 (e.g., such as floating wall panels of combustor 16) must be adequate to achieve the expected life of engine component 22. In some cases, this can be achieved by means of protection such as thermal barrier coatings, diffusion air cooling holes and/or by conducting the heat through one or more heat-extracting features 24 that can extract heat from engine component 22 and dissipate the heat into the surrounding environment such as a cooling fluid for example.

Engine component 22 may comprise base portion 26 manufactured by one or more first manufacturing processes (e.g., sheet metal forming, forging, casting, machining, grinding and/or other material-removal techniques). Base portion 26 may have first surface 28 for exposure to a source of heat and second surface 30. First surface 28 may, for example, be an inside surface of a wall of combustor 16 and facing hot combustion gases inside of combustor 16 or an inside surface of turbine casing 20 which may also be exposed to a relatively hot gases. Engine component 22 may comprise one or more heat-extracting features 24 protruding from second surface 30. For example the one or more heat-extracting features 24 may be added on second surface 30 using one or more second manufacturing processes different from the first manufacturing process(es). For example, the second manufacturing process used to add heat-extracting features 24 may be an additive material process such as laser powder deposition.

Base portion 26 may have a substantially annular configuration where first surface 28 may be a radially inner surface of base portion 26 and second surface 30 may be a radially outer surface of base portion 26. For example, second surface 30 may face radially outwardly from central axis CL. In some embodiments, base portion 26 may have an overall diameter of about two to three feet for example. In some embodiments, base portion 26 may have an overall dimension (i.e., width, length, height, diameter) of at least 24 inches (60 cm). In some embodiments, base portion 26 may have an overall dimension of at least 6 inches (15 cm) up to 60 inches (150 cm). Second surface 30 may be opposite first surface 28 so that second surface 30 may not face the heat source to which first surface 28 may be exposed. Accordingly, heat from the heat source may be conducted through the thickness of base portion 26 (i.e., between first surface 28 and second surface 30), conducted into heat-extracting feature(s) 24 and dissipated into the surrounding environment by convection into a cooling fluid such as air for example. Heat-extracting features 24 may serve as a heat sink for cooling base portion 26. Heat-extracting feature(s) 24 may provide surface area that facilitates dissipation of heat by convection for example.

As shown in the figures, each heat-extracting feature 24 may comprises a substantially columnar structure but the methods disclosed herein could be used for manufacturing components having one or more heat-extracting features 24 of different shapes and configurations than those illustrated herein. In some embodiments, engine component 22 may comprise one or more arrays of heat-extracting features 24. In some embodiments, all heat-extracting features 24 may be of substantially the same shape and size. Alternatively, engine component 22 may comprise heat-extracting features 24 of different shapes and sizes depending on the heat extraction requirements in different regions of engine component 22.

The distribution of heat-extracting features 24 may be uniform or non-uniform across second surface 30 or parts thereof. Similarly, the density of heat-extracting features 24 across second surface 30 may be uniform or non-uniform. In some embodiments, heat-extracting features 24 may have a substantially cylindrical configuration with a substantially circular cross-sectional profile. In some embodiments the spacing between heat-extracting features 24 as illustrated in FIG. 2 may be about 0.05 inch (1.3 mm) to about 0.06 inch (1.5 mm). In some embodiments, one or more heat-extracting features 24 may have a cross-sectional dimension (e.g., diameter) of about 0.03 inch (0.8 mm) to about 0.06 inch (1.5 mm).

In some embodiments, heat-extracting features 24 could be added to base portion 26 at a density of about 25 or more heat-extracting features 24 per square inch (6.5 cm²) of second surface 30. In some embodiments, heat-extracting features 24 could be added at a density of 100 or more heat-extracting features 24 per square inch (6.5 cm²) of second surface 30 depending on the size and spacing of heat-extracting features 24. In various embodiments, a plurality of heat-extracting features 24 could have a density of between 25 and 100 heat-extracting features 24 per square inch (6.5 cm²) of second surface 30.

The number, size, spacing, height and shape of heat-extracting features 24 may be selected to achieve a desired amount of heat extraction from engine component 22. For example, heat-extracting features 24 may have a substantially “pin” type shape (e.g., a columnar structure) and may protrude from second surface 30. The specific geometries of heat-extracting features 24 illustrated herein are provided for example only and it is understood that heat-extracting features 24 could be of different geometries than those illustrated herein. For example, in some embodiments, heat-extracting features 24 could be fin-shaped.

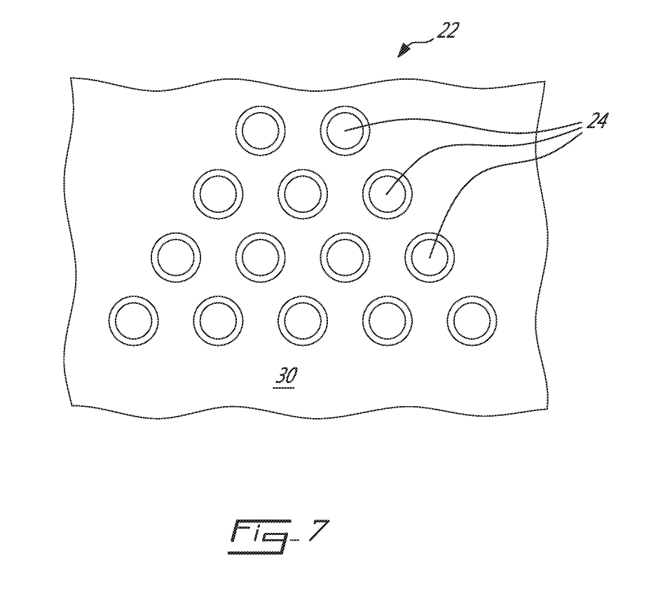

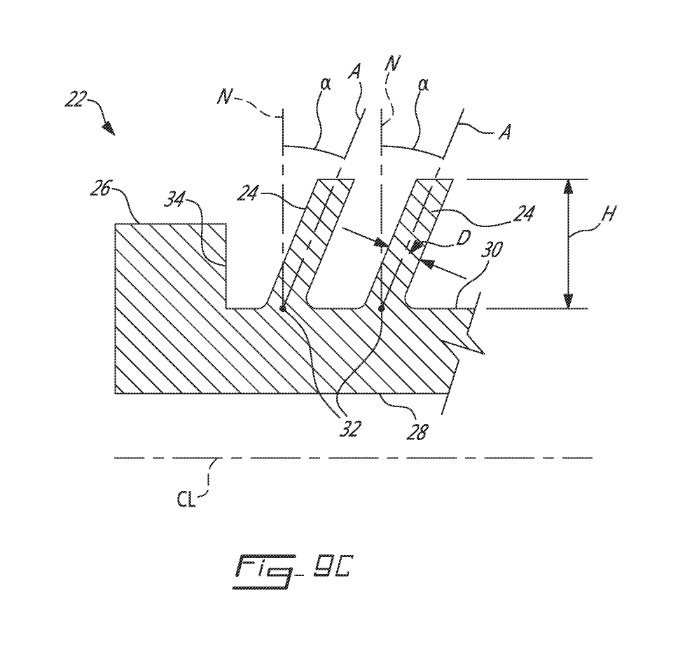

In various embodiments, heat-extracting features 24 may have solid or hollow configurations. For example, one or more heat-extracting features 24 could comprise hollow tubes instead of solid pins. In some embodiments, heat-extracting feature may have an outer cross-sectional dimension perpendicular to the longitudinal axis and a height along a normal to second surface 30 where the height is three or more times the outer cross-sectional dimension (see normal N and longitudinal axis A in FIG. 6). For example, heat-extracting feature 24 may have a height that is about three times its diameter (see height H and diameter D in FIG. 9C).

In various embodiments, second surface 30, upon which heat-extracting features 24 are added, may be non-planar (e.g., curved, convex, concave, thoroidal) and/or flat as illustrated herein. In some embodiments, second surface 30 may comprise one or more curved regions and one or more flat regions. For example, the curvature of surface 30 may vary between regions so that second surface 30 may comprise convex, concave and/or flat regions. In some embodiments, second surface 30 may be doubly curved (e.g., curved about two different axes, double convex, double concave). In some embodiments, second surface 30 may be convex as illustrated in FIG. 2.

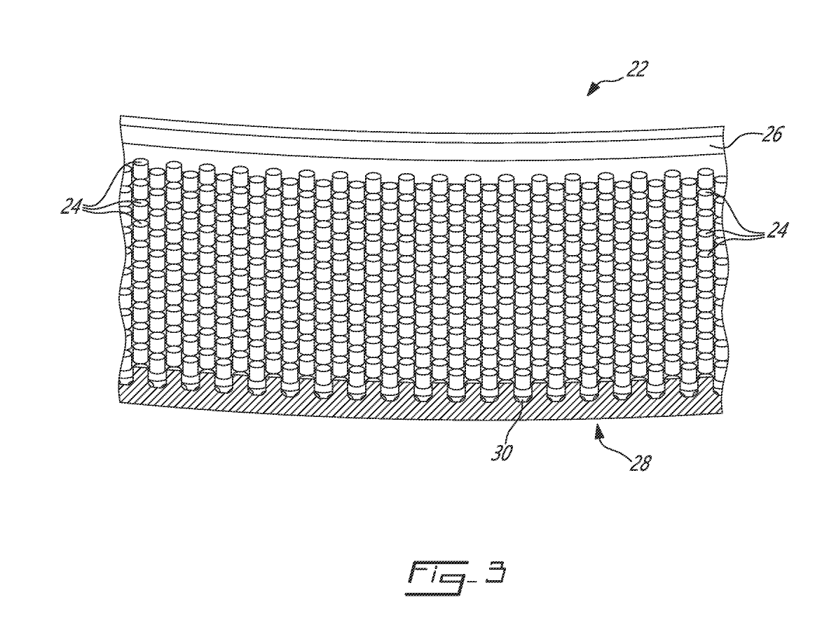

FIG. 3 is a perspective view of another exemplary portion of an annular gas turbine engine component 22 which may be manufactured using the methods disclosed herein. In the example of FIG. 3, second surface 30, from which heat-extracting features 24 are added, is illustrated as being concave.

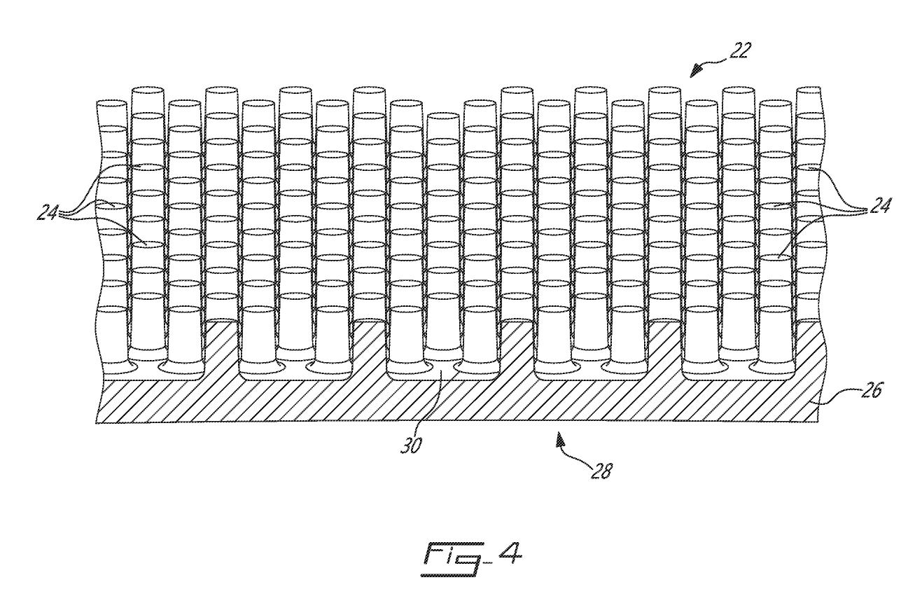

FIG. 4 is a perspective view of another exemplary portion of gas turbine engine component 22 which may be manufactured using the methods disclosed herein. In the example of FIG. 4, second surface 30, from which heat-extracting features 24 are added, is illustrated as being substantially flat.

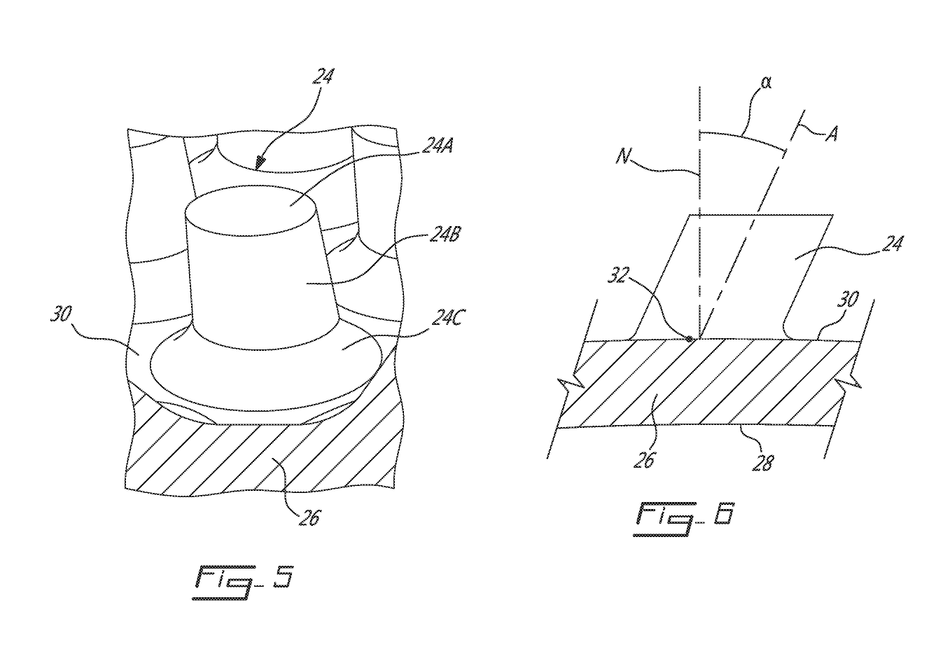

FIG. 5 is an enlarged perspective view of an exemplary heat-extracting feature 24 of engine component 22. Heat-extracting feature 24 may have any suitable shape and may protrude from second surface 30 to provide one or more paths for heat to be extracted from base portion 26 (e.g., by conduction) and dissipated into the surrounding environment (e.g., by convection into a cooling fluid).

Heat-extracting feature 24 may comprise top 24A, body 24B and bottom 24C. In some embodiments, heat-extracting feature 24 may have a substantially cylindrical shape. In some embodiments, heat-extracting feature 24 may have a substantially circular cross-sectional profile end/or a non-circular cross-sectional profile. In some embodiments, heat-extracting features 24 may have a uniform cross-section (e.g., constant diameter from top 24A to bottom 24C). In some embodiments, heat-extracting feature 24 may be tapered on bottom 24C may have a larger cross-sectional dimension (e.g., diameter) than top 24A. In some embodiments, heat-extracting feature 24 may have a larger cross-sectional area at or near bottom 24C than at or near top 24A. In some embodiments, the intersection between heat-extracting feature 24 and second surface 30 may be filleted to provide a contoured transition between heat-extracting feature 24 and second surface 30. The filleted portion may be produced using additive manufacturing as well.

FIG. 6 is an enlarged side elevation view of another exemplary heat-extracting feature 24 of engine component 22. The individual orientation of heat-extracting features 24 may be substantially uniform or non-uniform across some or all of second surface 30. In various embodiments, one or more of heat-extracting features 24 may each have a respective longitudinal axis A that may be normal or non-normal to second surface 30 at the location of the respective heat-extracting feature 24. For example, longitudinal axis A of one or more heat-extracting features 24 may be oriented based on (e.g., in relation to) the curvature of second surface 30. As shown in FIG. 6, longitudinal axis A may be non-parallel to normal axis N of second surface 30 at the location of heat-extracting feature 24. In other words, one or more heat-extracting features 24 may be added on second surface 30 along a general direction that is non-perpendicular to second surface 30 at the location of bottom 24C of heat-extracting surface 24.

In various embodiments, longitudinal axis A of one or more heat-extracting features 24 may be oriented based on the specific function of engine component 22 and the requirements for heat extraction from engine component. In some embodiments, one or more heat-extracting features 24 may be oriented so that longitudinal axis A is at an angle α of at least 5° from normal axis N of second surface 30 taken at the location of bottom 24C of the corresponding heat-extracting feature 24. In some embodiments, one or more heat-extracting features 24 may be oriented so that angle α is 15° or less from normal axis N of second surface 30 taken at the location of bottom 24C of the corresponding heat-extracting feature 24. Alternatively, one or more heat-extracting features 24 may be oriented so that angle α is more than 15° from normal axis N of second surface 30 taken at the location of bottom 24C of the corresponding heat-extracting feature 24. In some embodiments, one or more heat-extracting features 24 may be oriented so that angle α is between 10° and 15° from normal axis N of second surface 30 taken at the location of bottom 24C of the corresponding heat-extracting feature 24. In some embodiments, one or more heat-extracting features 24 may be oriented so that angle α is between 5° and 15° from normal axis N of second surface 30 taken at the location of bottom 24C of the corresponding heat-extracting feature 24.

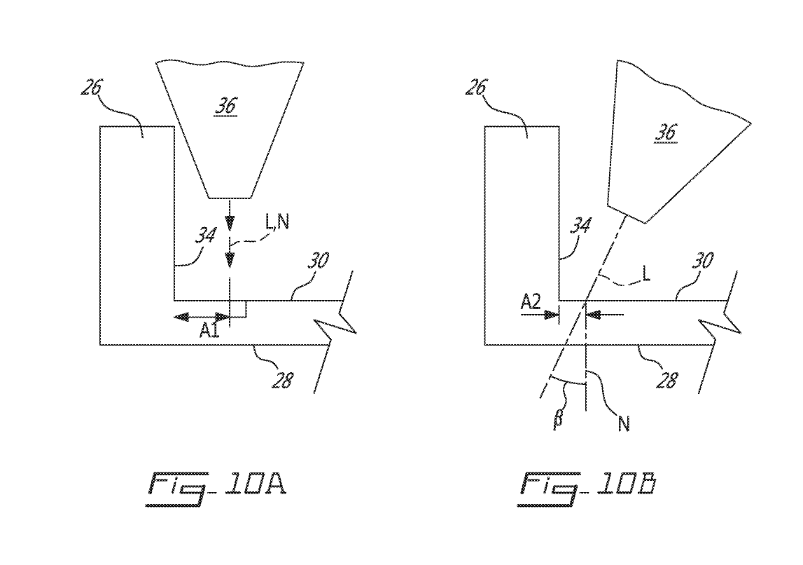

In some situations, the inclination of heat-extracting feature 24 relative to second surface 30 may provide some advantages. For example, the inclination may provide an increased surface area available for heat transfer for a given overall height H (shown in FIG. 9C) of heat-extracting feature 24. The inclination may provide an increased surface area available for heat transfer in a given volume containing one or more heat-extracting features 24. Also, as shown in FIGS. 9C, 10A and 10B the inclination of heat-extracting feature 24 may facilitate the addition of such heat-extracting features 24 near side wall 34 (shown in FIG. 9C) using additive manufacturing (see FIGS. 10A and 10B).

The inclined orientation of heat-extracting feature 24 may be achieved using known or other methods depending on the specific additive manufacturing process used. For example, using a laser material deposition process, the desired angle α may be achieved by depositing subsequent layers of material to follow longitudinal axis A via suitable control of the multi-axis CNC motion system. In some embodiments, the desired angle α may be achieved by controlling the relative position between the substrate and the additive manufacturing apparatus (i.e., laser head and/or powder delivery nozzle).

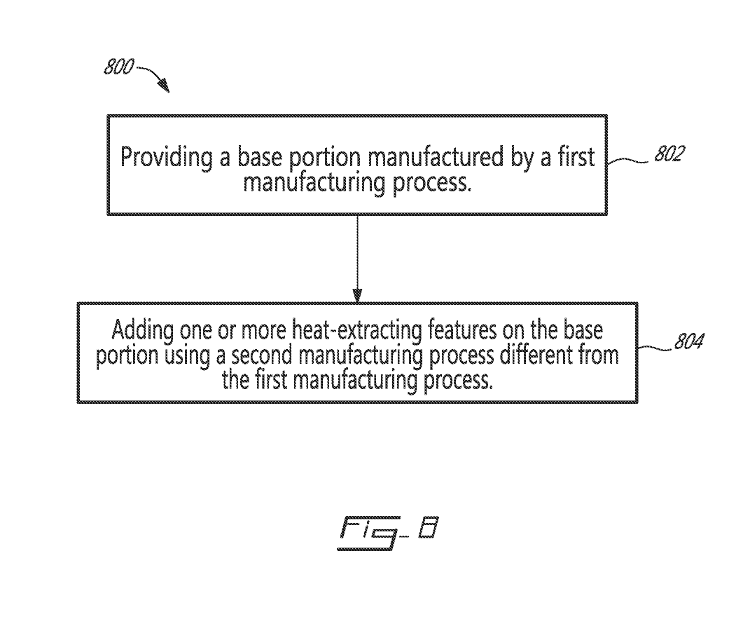

FIG. 7 is a top plan view of part of second surface 30 of engine component 22 onto which a plurality of heat-extracting features 24, arranged in a pattern, have been added. As explained above, the positioning and density of heat-extracting features 24 may be selected based on the heat extraction requirements for engine component 22. Accordingly, the distribution of heat-extracting features 24 may be non-uniform across second surface 30 such that, for example, a higher density of heat-extracting features 24 may be located in areas of second surface 30 where a higher heat-extracting capacity may be required.

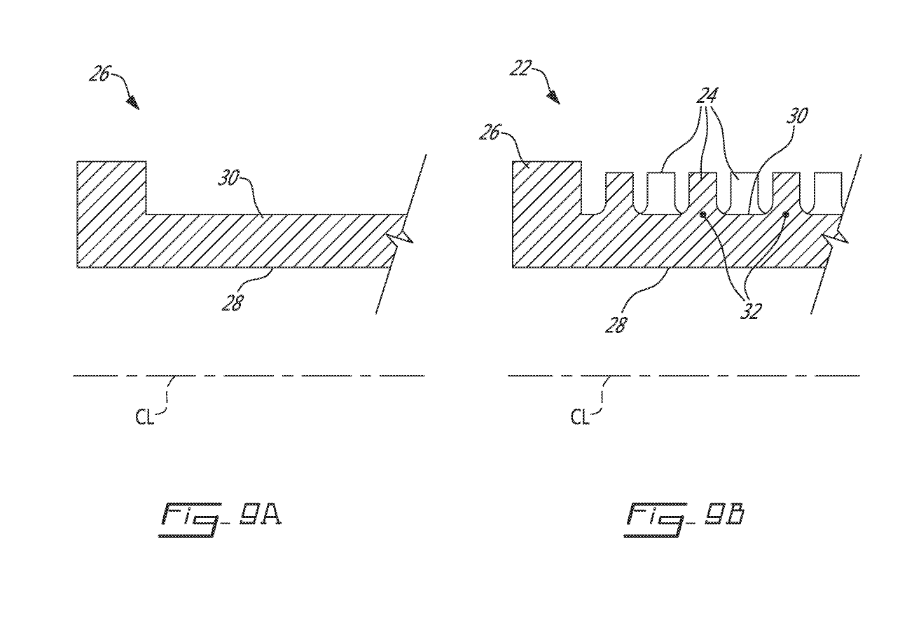

FIG. 8 is a flowchart illustrating an exemplary method 800 for manufacturing engine component 22 as described herein. Method 800 may comprise providing base portion 26 manufactured by one or more first manufacturing process(es) (see block 802) and adding one or more heat-extracting features 24 from base portion 26 using a second manufacturing process (e.g., additive manufacturing process) different from the first manufacturing process(es). Method 800 may also comprise manufacturing base portion 26 using the first manufacturing process.

As explained above, base portion 26 may comprise first surface 28 for exposure to a source of heat such as combustion gas inside of combustor 16 for example. Base portion 26 may also include second surface 30 which may be non-planar and onto which the one or more heat-extracting features 24 may be added.

In some embodiments, the first manufacturing process used to manufacture base portion 26 may, for example, include casting, machining and/or sheet metal forming and the second manufacturing process used to add heat-extracting features 24 may be an additive manufacturing process as described above and which is not used to manufacture base portion 26. Accordingly, base portion 26 may serve as a substrate for adding heat-extracting features 24. The addition of heat-extracting features 24 to base portion 26 using additive manufacturing may produce a metallurgical bond between base portion 26 and each heat-extracting feature 24. Depending on the type of additive manufacturing process and materials used, the interface (see item 32 in FIGS. 6 and 9B) between heat-extracting features 24 may be substantially metallurgically sound. In some embodiments, no other filler materials (e.g., from welding and/or brazing) may be necessary to achieve suitable bonding between heat-extracting features 24 and base portion 26.

The use of additive manufacturing may also permit the use of a material for heat-extracting features 24 that is the same or different from the material of base portion 26. In various embodiments, the material used for adding heat-extracting features 24 may be compatible with the material of base portion 26 in order to achieve respective metallurgical bonds between heat-extracting features 24 and base portion 26. Various materials may be suitable for base portion 26 and heat-extracting features 24 depending on the specific application. For a floating wall panel of combustor 16, a suitable material for base portion 26 may comprise a cast Ni-based alloy. In some embodiments, the material of base portion 26 may have a relatively low weldability but the use of an additive manufacturing process with a relatively low heat input may permit the addition of heat-extracting features 24 to base portion 26. For a floating wall panel of combustor 16 a suitable material for heat-extracting features 24 may be of the type known under the trade name INCONEL.

Whether or not the same material is used for both base portion 26 and heat-extracting features 24, the fact that different manufacturing processes are used for manufacturing each parts may result in the material of base portion 26 having one or more material (e.g., mechanical) properties that are different from that/those of the material of heat-extracting features 24. This may be due at least in part to the materials of base portion 26 and heat-extracting features 24 having different microstructures inherent to the different manufacturing processes used to produce them.

As described above, second surface 30 of base portion 26 may be flat, convex, concave or otherwise non-planar. Accordingly, the profile of second surface 30 may be taken into consideration in the additive manufacturing process. For example, the relative movement between the laser beam/powder stream and base portion 26 may be controlled (e.g., via a CNC motion system) so as to deposit material along trajectory that conforms to the surface profile of second surface 30 in order to maintain second surface 30 and/or subsequent deposited layers into a focal zone of the laser beam and consequently permit forming a molten pool as described above.

FIG. 9A is a cross-sectional view of base portion 26 of engine component 22 of FIG. 2 without heat-extracting features 24 added thereon, taken along line 9-9 in FIG. 2. FIG. 9B is a cross-sectional view of base portion 26 of engine component 22 of FIG. 2 with a plurality of heat-extracting features 24 added thereon, taken along line 9-9 in FIG. 2. Base portion 26 may serve as a substrate for adding one or more heat-extracting features 24. Base portion 26 may have a substantially annular configuration where the geometry of base portion 26 comprises the cross-sectional profile illustrated in FIG. 9A that is revolved about axis CL, which may also correspond to the central axis of engine 10 (see FIG. 1). FIG. 9B also indicate the location of interfaces 32 between base portion 26 and respective heat-extracting features 24.

The addition of heat-extracting features 24 using additive manufacturing may permit such heat-extracting features 24 to be added to existing engine components 22 so that such heat-extracting features 24 may be retrofitted onto existing engine components 22. The use of additive manufacturing may also permit the repair of existing components 22. For example, worn heat-extracting features 24 may be repaired by adding additional material to existing heat-extracting features 24. For example, old heat-extracting features 24 on an existing component 22 could be removed by grinding/machining and new heat-extracting features 24 could subsequently be added by additive manufacturing.

FIG. 9C is a cross-sectional view of another exemplary base portion 26 of engine component 22 with inclined heat-extracting features 24 disposed in proximity to side wall 34, taken along line 9-9 in FIG. 2. Side wall 34 may intersect second surface 30. For example, side wall 34 may be substantially perpendicular to second surface 30. As explained above, the inclination of longitudinal axis A of heat-extracting features 24 may provide advantages in comparison with being normal to second surface 30. For an overall height H of heat-extracting feature 24 measured along normal N of second surface 30, the amount of surface area available for convective heat transfer may be higher when longitudinal axis A is inclined relative to the normal N. Also, the inclination of longitudinal axis A may also provide a heat transfer path that leads away from side wall 34. In some situations, this may further enhance heat extraction from second surface 30 near side wall 34. In some embodiments, heat-extracting feature 24 may have height H and an outer cross-sectional dimension D perpendicular to longitudinal axis A where height H is three or more times outer cross-sectional dimension D of heat-extracting feature 24. In some embodiments, heat-extracting feature 24 may lean away from side wall 34.

FIGS. 10A and 10B are schematic representations of part of an additive manufacturing apparatus 36 (referred hereinafter as “AM apparatus 36”) positioned near side wall 34 in preparation for the addition of heat-extracting feature 24. In some embodiments, AM apparatus 36 may comprise one or more laser heads and/or one or more powder nozzles. As mentioned above, the inclination of heat-extracting feature 24 may be achieved by controlling the relative position between AM apparatus 36 and base portion 26. In some embodiments, the relative orientation between AM apparatus 36 and base portion 26 may be modified to build heat-extracting feature 24 at an inclination angle α. For example, the relative orientation of between AM apparatus 36 and base portion 26 may be adjusted so that an axis L of AM apparatus 36 is at an angle β from normal N of second surface 30. In some embodiments, angle β may be substantially the same as angle α of longitudinal axis A of heat-extracting feature 24.

The inclination of axis L relative to normal N may permit the addition of heat-extracting feature 24 closer to side wall 34. As shown in FIG. 10A, when axis L of AM apparatus 36 is substantially parallel to normal N of second surface 30, the minimum distance A1 from side wall 34 at which heat-extracting feature 24 may be added may be limited by the physical size of AM apparatus 36 and also the requirement of avoiding a collision between AM apparatus 36 and side wall 34. As shown in FIG. 10B, the inclination of axis L of AM apparatus 36 with respect to normal N of second surface 30 may allow for heat-extracting feature 24 at a distance A2 from side wall 34 where distance A2 may be smaller than distance A1 of FIG. 10A.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance blocks may be added, deleted, or modified. The present disclosure may be embodied in other specific forms without departing from the subject matter of the claims. Also, one skilled in the relevant arts will appreciate that while the methods and components disclosed and shown herein may comprise a specific number of elements, the methods and components could be modified to include additional or fewer of such elements. The present disclosure is also intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

What is claimed is:

1. A method for manufacturing a component of a turbine engine, the component for exposure to a heat source when used in the turbine engine, the method comprising:
providing a base portion manufactured by a first manufacturing process, the base portion comprising a first surface and a second surface, the first surface for exposure to the heat source and the second surface for exposure to a cooling fluid when used in the turbine engine; and
adding a heat-extracting feature on the second surface of the base portion using a second manufacturing process different from the first manufacturing process, the second manufacturing process comprising an additive manufacturing process, the heat-extracting feature having a longitudinal axis being non-normal to the second surface at a location of the heat-extracting feature on the second surface.

2. The method as defined in claim 1, wherein the longitudinal axis is at least 5° from a normal of the second surface taken at the location of the heat-extracting feature.

3. The method as defined in claim 1, wherein the longitudinal axis is between 10° and 15° from a normal of the second surface taken at the location of the heat-extracting feature.

4. The method as defined in claim 1, comprising adding a plurality of heat-extracting features on the second surface of the base portion where the plurality of heat-extracting features has a density of between 25 and 100 heat-extracting features per square inch (6.5 cm²) of area of the second surface.

5. The method as defined in claim 1, comprising adding a plurality of heat-extracting features from the second surface of the base portion where the plurality of heat-extracting features has a density of at least 100 heat-extracting features per square inch (6.5 cm²) of area of the second surface.

6. A gas turbine engine component comprising:
a base portion comprising a first surface and an opposite second surface, the first surface for exposure to a heat source and the second surface for exposure to a cooling fluid when used in the gas turbine engine; and
a heat-extracting feature on the second surface of the base portion, the heat-extracting feature having a longitudinal axis being non-normal to the second surface at a location of the heat-extracting feature on the second surface.

7. The component as defined in claim 6, wherein the base portion has an annular configuration having a central axis and the second surface faces radially outwardly from the central axis.

8. The component as defined in claim 6, wherein the longitudinal axis is between 10° and 15° from a normal of the second surface taken at the location of the heat-extracting feature.

9. The component as defined in claim 6, comprising a plurality of heat-extracting features on the second surface of the base portion where the plurality of heat-extracting features has a density of between 25 and 100 heat-extracting features per square inch (6.5 cm²) of area of the second surface.

10. The component as defined in claim 6, comprising a plurality of heat-extracting features on the second surface of the base portion where the plurality of heat-extracting features has a density of at least 100 heat-extracting features per square inch (6.5 cm²) of area of the second surface.

11. The component as defined in claim 6, wherein the second surface of the base portion is non-planar.

12. The component as defined in claim 6, wherein the heat-extracting feature has an outer cross-sectional dimension perpendicular to the longitudinal axis and a height normal to the second surface where the height is three or more times the outer cross-sectional dimension.

13. The component as defined in claim 6, wherein an overall dimension of the base portion is at least 6 inches (60 cm).

14. The component as defined in claim 6, wherein the base portion comprises a side wall intersecting the second surface and the heat-extracting feature leans away from the sidewall.

15. A gas turbine engine comprising the component defined in claim 6.
